(19) United States
(12) Patent Application Publication
(10) Pub. No.: US 2025/0026539 A1
(43) Pub. Date: Jan. 23, 2025

(54) Extruder Apparatus

(71) Applicant: Andrew C. Scherer, Santa Monica, CA (US)

(72) Inventor: Andrew C. Scherer, Santa Monica, CA (US)

(21) Appl. No.: 18/367,433

(22) Filed: Sep. 12, 2023

Related U.S. Application Data
(63) Continuation-in-part of application No. 18/223,163, filed on Jul. 18, 2023.

(51) Int. Cl. B05C 17/005

(52) U.S. Cl. CPC B65D 35/28

(57) ABSTRACT

In one embodiment, a first container holds viscous material which is to be extruded. The first container has a spout with a pass-through director to pass portions of the viscous material. A fitment is included for coupling the first container to the spout. Wherein the spout is mechanically coupled to the fitment such that portions of the viscous material of the first container are delivered to a precise location exterior of the first container and passed through the fitment by means of an extrusion process to a specific location. Other embodiments are also disclosed.

### CROSS-REFERENCE TO RELATED APPLICATION

The present application is a continuation-in-part (CIP) of U.S. patent application Ser. No. 18/223,163.

### BACKGROUND OF THE INVENTION

The present invention relates generally to extrusion devices, and, more specifically, to an extrusion apparatus that provides simple access to precise amounts of viscous material from a container.

Transferring viscous materials is known in the art. For example, U.S. Pat. No. 10,631,906 issued to Globerman, et al., discloses concepts related to transferring viscous materials from a first to a second container by means of a transfer piston mechanically coupled between the two containers.

In general, manufacturing of various metallic materials often include extrusion methodologies. For example, although steel is difficult to shape into custom shapes and sizes, steel is often subject to a heating and cooling process wherein chemical properties of the steel are changed to make extruding the metallic material possible. These extrusion techniques allow efficient changing of the form and shape of the steel using techniques such as extrusion.

Another extrusion technique can be found in non-metallic material such as caulk in a caulking gun. Caulk is a viscous material that is intended to be placed into small cracks of places like drywall joints that are formed during construction. A typical caulking gun requires a cartridge having a large shaft equal to the length of the cartridge or tube of caulk in order to extrude the caulk from the caulk cartridge through a spout where the caulking can be controlled for placement into desired locations.

In still another extrusion technique, a medical procedure includes a container with an extrusion plate which presses material from the container into a channel and through a spout. Further, there is an outlet for dispensing the material into a directed flow path. This is known as “vertebroplasty.”

Vertebroplasty is a medical treatment that injects cement into a cracked or broken spinal bone to help relieve pain. Spinal bones are called vertebrae. Vertebroplasty is used most often to treat a type of injury called a compression fracture. These injuries are usually caused by osteoporosis, a condition that weakens bone.

Extrusion is also known for extruding food products. Extrusion of food products often includes extrusion of sandwich condiments. These condiments are often extruded from a container to a specific location by introducing air into the container. A pump handle on the container can be used to extrude the contents from the container.

Contents such as sandwich condiments, where a user can find pump action containers of popular condiments available where a user can easily put desired condiments onto a sandwich.

What is needed is an extruder that can be used to more efficiently extrude both food and non-food materials from a first container to a specific location. The following disclosure relates to improvements in the extrusion art; non-obvious improvements, as demonstrated by the failure of those of ordinary skill in the art to implement such improvements after having available the benefit of these earlier extrusion disclosures.

### SUMMARY OF THE INVENTION

It has been discovered that at least the aforementioned challenges are resolved by an extrusion apparatus as disclosed herein. Upon viewing the present disclosure, one of ordinary skill in the art will appreciate that variations of principles according to the present invention could be contemplated.

For example, in one inventive embodiment, an extruder apparatus is disclosed that has at least two clamp plates. The clamp plates are configured to hold a first container.

The first container contains a viscous material. The viscous material is to be extruded through a spout of the first container by compressing the first container with the clamp plates.

The spout of the first container passes portions of the viscous material to a specific location exterior to the first container when the clamps are compressed by the clamp plates.

A fitment is included for coupling to the first container via the spout of the first container. The spout is mechanically coupled to the fitment such that portions of the viscous material may pass through the fitment to the specific location by means of an extrusion process.

The first container holds the viscous material which could be a material such as fudge for extrusion onto something like ice cream or milk; lotion for extrusion onto something like human skin such as found on hands or a face; or non-human-friendly material such as grease for extrusion onto something like an axle on a car.

The extruder apparatus could also include a pass-through tube for a spout, the spout being made of a metallic or other material.

In another embodiment an extruder apparatus includes at least two clamp plates. These clamp plates are configured to surround or hold a first container.

The first container holds a viscous material. The viscous material is to be extruded through a spout of the first container by compressing the first container with the clamp plates.

The clamp plates compress the first container such that a portion of the viscous material of the first container may be extruded through the spout of the first container.

The portions of the viscous material are passed to a specific location by means of a fitment that is coupled to the first container via the spout.

Finally, the spout is mechanically coupled to the fitment such that the portions of the viscous material of the first container are delivered to the specific location exterior of the first container as the portions of the viscous material are passed through the fitment. The whole process is an extrusion process for extruding detailed amounts of viscous material to a specific location.

In certain embodiments, this extruder apparatus passes viscous material that is selected from the group consisting of: fudge, lotion, and grease. The viscous material could be chocolate fudge for something like ice cream, lotion for something like human skin, or axle grease for something like an axle of an automobile.

Clamp plates are included in the extruder apparatus to manipulate the viscous material that is found within the first container. The clamp plates enable at least a portion of the viscous material of the first container to be optimally extruded to a specific location.

The fitment includes a pass-through opening for evacuating contents of the first container, and at least one clamp plate to engage with the first container such that the opening hole accepts the fitment.

The foregoing is a summary and thus contains, by necessity, simplifications, generalizations, and omissions of detail; consequently, those skilled in the art will appreciate that this summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings.

FIG. 1 is a general block diagram drawing showing an embodiment of an extruder apparatus according to principles of the present invention;

FIG. 2 is a general block diagram showing more detail of a location (also known as a second container) from the drawing of FIG. 1 where fudge is extruded onto ice cream;

FIG. 3 is a general block diagram showing more detail of another location (second container) from the drawing of FIG. 1 where lotion is extruded onto a human hand;

FIG. 4 is a general block diagram showing more detail of a second container from the drawing of FIG. 1 where grease is extruded onto an axle; and

FIG. 5 is a more detailed drawing of the first container from the drawing of FIG. 1 where clamp plates are illustrated for extruding viscous material from the first container into a location.

### DETAILED DESCRIPTION

The following provides a detailed description of examples of the present invention and should not be taken to be limiting of the invention itself. Rather, any number of variations may fall within the scope of the invention, which is defined in the claims following this detailed description.

Reference will now be made in detail to embodiments of the invention illustrated in accompanying drawings. Whenever possible, the same or similar reference numerals are used in the drawings and the description to refer to the same or like parts, acts, or steps. The drawings are in simplified form.

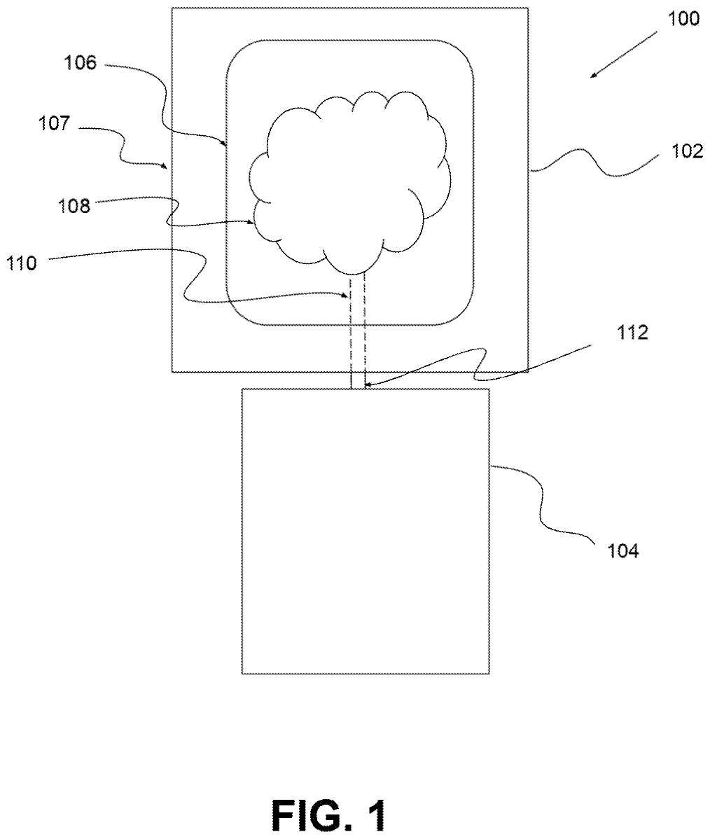

FIG. 1 is a general block diagram drawing showing an embodiment of an extruder apparatus 100 according to principles of the present invention.

In the illustrated embodiment, extruder apparatus 100 is illustrated as having a first container 102 and a second container 104 (as mentioned above, also known as a location). In general, first container 102 is related to an extruder mechanism 106. The extruder mechanism 106 has clamp plates 107, not shown in detail.

First container 102 is positioned between clamp plates 107. The clamp plates 107 are also known as compression plates where at least one of these compression plates move to compress first container 102. Clamp plates 107 operate similarly to two orchestral cymbals that come together, but when coming together, these “cymbals” will compress first container 102 to extrude a viscous material 108 from first container 102.

In a preferred embodiment, extrusion mechanism 106 operates through clamp plates 107 in a pulley system that allow a user of extruder apparatus 100 to extrude detailed amounts of viscous material 108 through a spout 110, and through a pass-through director 112 to a specific location also known as a second container 104.

As understood by those of ordinary skill in the art and viewing the illustrated extruder apparatus 100, viscous material 108 could be a human-friendly material, even an edible condiment for human consumption such as caramel or fudge, that is placed upon a food product such as ice cream or bread of a sandwich. Viscous material 108 could also be a human-friendly external human application product such as hand lotion used to soften skin.

Further, viscous material 108 could be a non-human-friendly material such as grease for lubricating an axle of an automobile. Still further, viscous material 108 could even be another type of viscous material that is to be spread to precise locations in precise amounts such as during an intricate medical procedure.

Much of viscous material 108 may remain in first container 102 after a particular use of extruder apparatus 100. Of note, the remaining viscous material 108 can be preserved and prevented from leaking onto an undesirable location.

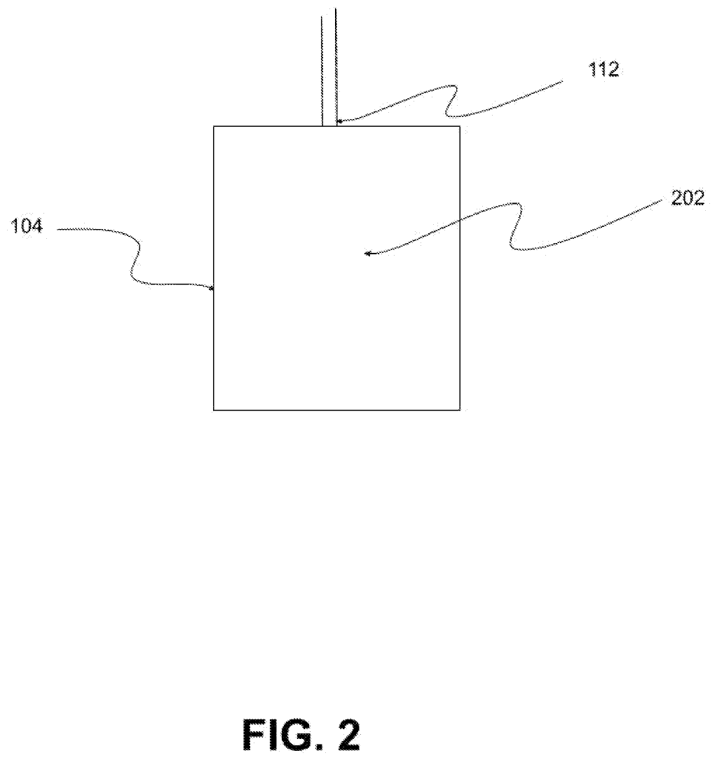

FIG. 2 is a general block diagram showing more detail of extruded material from second container 104 (otherwise known as specific location) of FIG. 1. In the FIG. 2 embodiment, second container 104 is ice cream 202 where fudge passes into second container 104 through pass-through director 112. Upon viewing FIG. 2, as appreciated by those of ordinary skill in the art, chocolate fudge can be the viscous material 108 that is extruded to second container 104. The chocolate fudge can be extruded in a particular amount to a precise location such as to a scoop of ice cream.

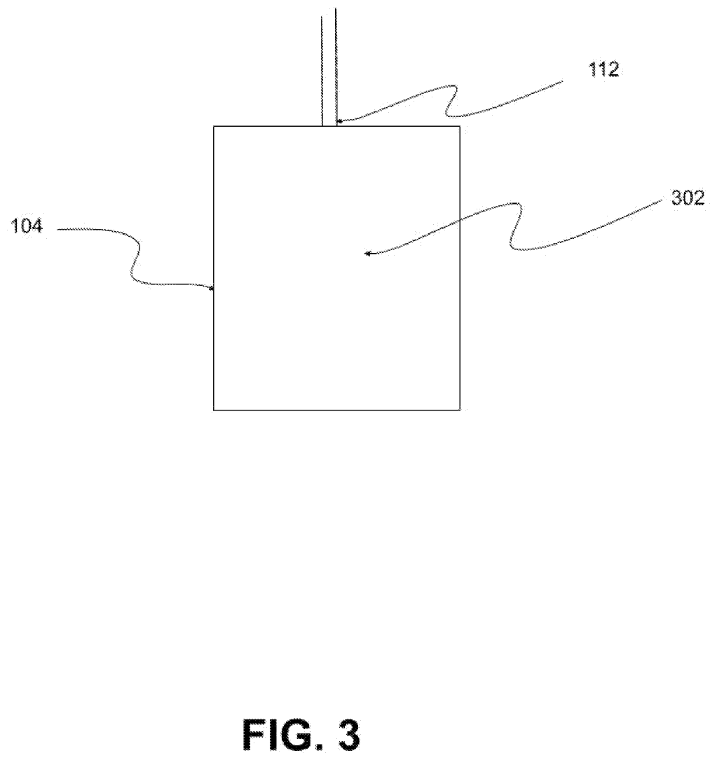

FIG. 3 is a general block diagram showing more detail of second container 104 from FIG. 1. In the FIG. 3 embodiment, second container 104 represents a human hand 302 where lotion passes onto second container 104 through pass-through director 112. In other words, lotion is extruded onto a human hand. Of course, the lotion can be extruded onto different places or body parts as needed.

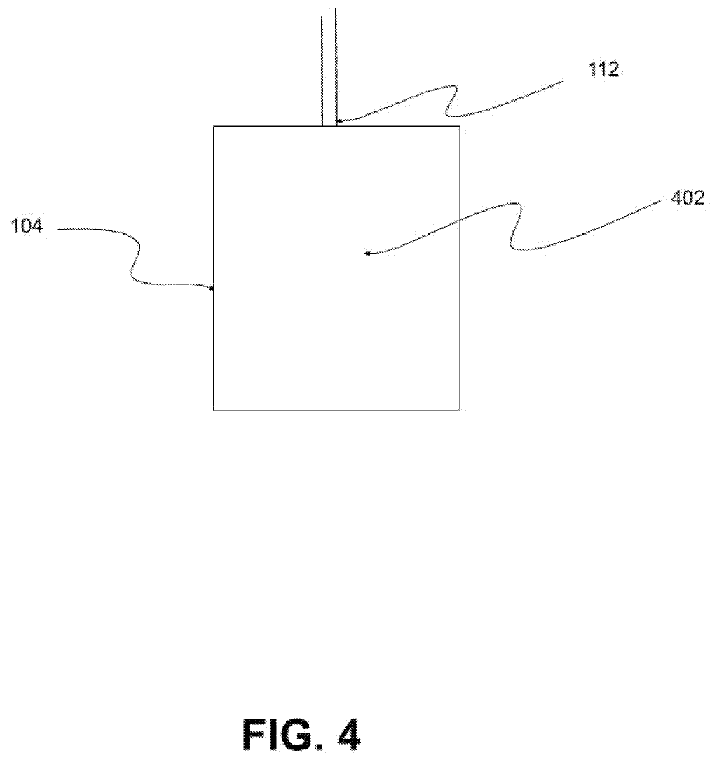

FIG. 4 is a general block diagram showing more detail of second container 104 from the drawing of FIG. 1. In the FIG. 4 embodiment, second container 104 represents a car axle 402 where grease is extruded or placed onto axle 402. As those of ordinary skill in the art will appreciate upon viewing FIG. 4, not only would car axle 402 be a suitable location for grease, but other mechanical things could benefit from application of similar grease or other viscous lubricant that is represented by viscous material 108 of FIG. 1.

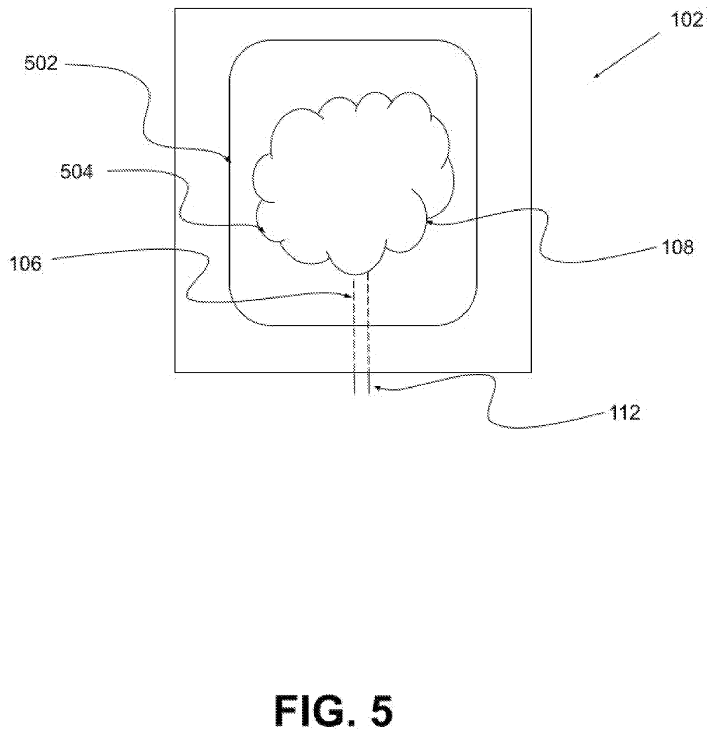

FIG. 5 is a more detailed drawing of first container 102 from the drawing of FIG. 1 where clamp plates 107 are illustrated for extruding viscous material 108 in precise amounts. As illustrated, viscous material 108 can be extruded from the first container 102 into a second container 104 for many reasons.

As previously disclosed, viscous material 108 is able to be extruded by extruder apparatus 100 to extrude many different types of viscous materials. As described above, these different viscous materials make extruder apparatus 100 valuable for many different purposes. Extruder apparatus 100 is able to be used to extrude human-friendly viscous material 108 such as a gooey substance like peanut butter, mayonnaise, honey, or another difficult to handle material.

Viscous material 108 of first container 102 can be dependent upon a user's selection for extrusion with extrusion apparatus 100. As stated, upon viewing, those of ordinary skill in the art can imagine a variety of materials such as food or non-food material like axle grease or oil paint. These different viscous materials are extruded using clamps in exactly the same way with a fitment that can be attached to an external spout where no container is held by the fitment. Two rigid clamping plates 107 typically compress a flexible container of viscous material 108 for extrusion through a cavity of different types.

Upon viewing the present disclosure, those of ordinary skill in the art will appreciate that other equivalent materials and steps could be substituted to realize the invention disclosed herein.

Although various disclosure embodiments have been described in the foregoing detailed description and illustrated in the accompanying drawings, it will be understood that the presently disclosed invention is not limited to the embodiments disclosed, but indeed may assume numerous arrangements, re-arrangements, modifications, and substitutions of elements or steps without departing from the spirit and intended scope of the invention herein set forth. The appended claims are to encompass within their scope all such changes and modifications as are within the true spirit and scope of this invention.

Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present.

For a non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

What is claimed is:

1. An extruder apparatus comprising:
at least two clamp plates, the at least two clamp plates being configured to accept a first container;
the first container for holding a viscous material, the viscous material is to be extruded through a spout of the first container by compressing the first container with the at least two clamp plates;
the spout of the first container passing portions of the viscous material to a specific location exterior to the first container when compressed by the at least two clamp plates;
a fitment for coupling to the first container via the spout of the first container; and
wherein the spout is mechanically coupled to the fitment such that the portions of the viscous material may pass through the fitment to the specific location by means of an extrusion process.

2. The extruder apparatus of claim 1 wherein the viscous material of the first container is fudge.

3. The extruder apparatus of claim 1 wherein the viscous material of the first container is skin lotion.

4. The extruder apparatus of claim 1 wherein the viscous material of the first container is grease.

5. The extruder apparatus of claim 1 wherein the spout of the first container comprises a pass-through tube.

6. The extruder apparatus of claim 5 wherein the pass-through tube is metallic.

7. An extruder apparatus comprising:
at least two clamp plates, the at least two clamp plates being configured to accept a first container;
the first container for holding a viscous material, the viscous material is to be extruded through a spout of the first container by compressing the first container with the at least two clamp plates;
the at least two clamp plates compressing the first container such that at least a portion of the viscous material of the first container is extruded through the spout of the first container and that the portions of the viscous material are passed to a specific location;
a fitment for coupling to the first container via the spout; and
wherein the spout is mechanically coupled to the fitment such that the portions of the viscous material of the first container are delivered to the specific location exterior of the first container as the portions of the viscous material are passed through the fitment by means of an extrusion process to the specific location.

8. The extruder apparatus of claim 7 wherein the viscous material of the first container is selected from the group consisting of: fudge, lotion, and grease.

9. The extruder apparatus of claim 8 wherein the viscous material of the first container is chocolate fudge.

10. The extruder apparatus of claim 8 wherein the viscous material of the first container is axle grease.

11. The extruder apparatus of claim 8 wherein the viscous material of the first container is skin lotion.

12. The extruder apparatus of claim 8 wherein the viscous material of the first container is caramel.

13. An extruder apparatus comprising:
a first container which holds viscous material to be extruded;
the first container having a spout to pass portions of the viscous material to a precise location;
a fitment for coupling to the first container via the spout; and
wherein the spout is mechanically coupled to the fitment of the first container such that portions of the viscous material of the first container are delivered to the precise location exterior of the first container by extrusion through the spout and passed through the fitment to the precise location.

14. The extruder apparatus of claim 13 wherein the precise location is ice cream.

15. The extruder apparatus of claim 13 wherein the precise location is human skin.

16. The extruder apparatus of claim 13 wherein the precise location is an auto axle.

17. The extruder apparatus of claim 13 wherein the extruder apparatus comprises multiple form factors.

18. The extruder apparatus of claim 13 wherein the extruder apparatus includes clamp plates designed to extrude viscous material from the first container, wherein the clamp plates compress at least a portion of the first container to optimally extrude the at least a portion of the first container's contents.

19. The extruder apparatus of claim 1 wherein the fitment includes a pass-through director for evacuating contents of the first container.

20. The extruder apparatus of claim 13 wherein a clamp plate engages with the first container such that an opening hole accepts the fitment.
